(19) United States
(12) Patent Application Publication
(10) Pub. No.: US 2004/0110853 A1
(43) Pub. Date: Jun. 10, 2004

(54) Process for preparing molded porous articles and the porous articles prepared therefrom

(76) Inventors: Louis Chun Wang, Raritan, NJ (US); Jens Ehlers, Hamminkeln (DE); Stanislaw Haftka, Oberhausen (DE)

Correspondence Address: WHITE & CASE LLP, PATENT DEPARTMENT, 1155 AVENUE OF THE AMERICAS, NEW YORK, NY, 10036, US

(21) Appl. No.: 10/640,830

(22) Filed: Aug. 13, 2003

Related U.S. Application Data
(60) Provisional application No. 60/404,575, filed on Aug. 20, 2002.

(51) Int. Cl. C08J 9/16

(52) U.S. Cl. 521/56

(57) ABSTRACT

The present invention relates to a process for forming a porous article. The process involves molding a shape from a molding powder comprising polyethylene polymer particles. The polyethylene polymer has a single modal molecular weight distribution. The molecular weight of the polyethylene polymer is within the range of about 800,000 g/mol to about 3,500,000 g/mol as determined by ASTM-D 4020. The particle size distribution of the particles of the polyethylene polymer are within the range of about 10 microns to about 1000 microns. Advantageously, the process provide a desirable processing window for producing articles with excellent porosity and strength. Porous articles made from the process are also disclosed.

### CROSS-REFERENCE TO RELATED APPLICATION

This application claims priority to U.S. provisional patent application serial No. 60/404,575, filed Aug. 20, 2002, the disclosure of which is incorporated herein in its entirety.

### FIELD OF THE INVENTION

The invention relates to the field of using synthetic polymer materials for molding porous articles.

### BACKGROUND

Ultra-high-molecular weight polyethylene (UHMW-PE), standard high-density polyethylene (HDPE) and low-density polyethylene (LDPE) have all been used as polymeric materials for producing different types of molded porous articles. Such articles include filter funnels, immersion filters, filter crucibles, porous sheets, pen tips, marker nibs, aerators, diffusers and light weight molded parts. However, the polyethylene formulations used in these applications are all associated with various disadvantages.

LDPE and standard HDPE, which include polyethylene of molecular weight up to 250,000 g/mol, yield good part strength but their melt behavior results in a narrow processing window with respect to both time and temperature. As result, there is a strong tendency toward reduced porosity and an increased quality inconsistency in the molded product. Furthermore, with LDPE or standard HDPE as the molding powder, the non-uniformity of heating within molds having complex geometric conduits tends to result in non-uniformity in the porosity of the product part.

In contrast to LDPE and standard HDPE, UHMW-PE formulations with an average molecular weight above 3,000,000 g/mol exhibit excellent processing forgiveness. Specifically, it is known in the art that UHMW-PE molding powders are characterized by a wide time and temperature processing window. However, these UHMW-PE formulations are known to result in rather weak molded products. Moreover, regional weak spots tend to be formed when UHMW-PE is used with molds having a complex geometric conduit. To maintain or improve the strength of porous articles made from UHMW-PE, U.S. Pat. No. 4,925,880 discloses the addition of a polyethylene wax to the UHMW-PE particles. However, the use of polyethylene wax in this manner restricts the time and temperature processing window and is thus associated with the same disadvantages as using LDPE and standard HDPE.

Therefore, there is still a need for improved processes which provide processing flexibility to produce articles with well controlled porosity and good mechanical strength. This invention provides such a new process and the porous articles prepared therefrom.

### SUMMARY OF THE INVENTION

The present invention relates to a process for forming a porous article. In accordance with the invention, a molding powder comprising polyethylene polymer particles is formed into a desired shape and heated to a temperature within the range of about 140° C. and about 300° C. In general, a molding pressure is normally not required. The polyethylene polymer has a single modal molecular weight distribution. The molecular weight of the polyethylene polymer is within the range of about 800,000 g/mol to about 3,500,000 g/mol as determined by ASTM-D 4020. The particle size distribution of the particles of the polyethylene polymer are within the range of about 10 microns to about 1000 microns. The present invention is also directed to porous articles prepared in accordance with the process of the present invention.

### DETAILED DESCRIPTION OF THE INVENTION

The present invention provides a process for using a polyethylene powder to produce molded porous articles having good porosity and strength. The polyethylene polymer used in the present invention has a single modal molecular weight distribution and generally exhibits a molecular weight of about 800,000 g/mol to about 3,500,000 g/mol as determined by ASTM-D 4020. As such, the molecular weight of the polyethylene polymer of the invention is higher than that of standard HDPE but below that of UHMW-PE. The particle size distribution of the particles of the polyethylene polymer is within the range of about 10 microns to about 1000 microns.

In accordance with various embodiments of the invention, the molecular weight of the polyethylene polymer may fall within any of the following molecular weigh ranges as determined by ASTM-D 4020: about 1,000,000 g/mol to about 2,600,000 g/mol; and about 1,000,000 g/mol to about 1,700,000 g/mol. Although any polyethylene polymer meeting the preceding requirements may be used, a commercial example of such a polymer is GUR® 4012 and GUR® 4022 produced by Ticona LLC. The specification range of the molecular weight for GUR® 4012 is about 927,000 to about 1,616,000 g/mol as determined by ASTM-D 4020. The mid-range of the specification is about 1,259,000 g/mol. GUR® 4022 has a molecular weight of 2,620,000 g/mol as determined by ASTM-D 4020.

Molded articles may be formed by a free sintering process which involves introducing the molding powder comprising the polyethylene polymer particles into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals.

The mold is heated in a convection oven, hydraulic press or infrared heaters to a sintering temperature between 140° C. and 300° C. In accordance with other embodiments of the invention, the sintering temperature may also fall within the following ranges: 160° C. to 300° C. and 180° C. to 240° C. The heating time varies and depends upon the mass of the mold and the geometry of the molded article. However, the heating time typically lies within the range of about 25 to about 100 minutes. During sintering, the surface of individual polymer particles fuse at their contact points forming a porous structure. Subsequently, the mold is cooled and the porous article removed. In general, a molding pressure is normally not required. However, in cases requiring porosity adjustment, a proportional low pressure can be applied to the powder.

Advantageously, parts made in accordance with the process of the invention and with the polyethylene powder of the described molecular weight range have an improved strength and porosity relative to UHMW-PE. The polyethylene powder of the invention provides excellent processing flexibility and much lower porosity reduction than standard HDPE and LDPE.

### EXAMPLES

In the following examples, porous products were prepared with a specified polyethylene powder and the physical properties of the products were tested. In accordance with each of the examples, the identified polymer grade was used in an unblended form. Tables 1 and 2 are directed to the process of the present invention using a polyethylene powder of the described molecular weight range. Tables 3-6 relate to comparative examples using a polyethylene powder having a molecular weight that falls outside of the range of the present invention. Each table provides the process conditions and characteristics of the porous product prepared by the corresponding process.

Test samples were prepared by forming porous plaques with a diameter of 140 mm and a thickness of 6.0-6.5 mm in a suitable mold. The mold is filled with the appropriate polymer and the sides are tapped to settle the powder for uniformity and to improve packing. The top of the mold is leveled, the mold is covered and placed into the convection oven. The sintering temperature and time are reported in the Table 1 for each example and specimen. The mold was then removed from the press and cooled quickly. The sample was removed from the mold and allowed to air cool for 40 minutes.

All of the molecular weights presented for the polyethylene compositions shown in Tables 1-6 are based on the current formula for ASTM D4020, except where otherwise noted. Flexural strength was determined according to DIN ISO 178 (1993). Average pore size was determined according to DIN ISO 4003. Pressure drop was determined using a porous specimen having a diameter of 140mm, a width of 6.2-6.5mm (depending on shrinkage) and an airflow rate of 7.5 m³/hour. Shrinkage was determined by measuring the deviation between the mold diameter and the porous plaque diameter.

TABLE 1
PRESENT INVENTION

| | | | | | | Average | | |
|---|---|---|---|---|---|---|---|---|
| | | | | Sintering | Pressure | pore | Flexural | |
| | | Mw × 10⁶ | | time | Drop | size | strength | |
| Example | Polymer | g/mol | Temperature ° C. | (min) | (mbar) | (μm) | (mPas) | Shrinkage % |
| 1a | GUR ® 4012¹ | 1.149 | 220 | 25 | 26 | 16 | 5.1 | 4.1 |
| 1b | GUR ® 4012 | 1.149 | 220 | 30 | 27 | 18 | 5.7 | 4.7 |
| 1c | GUR ® 4012 | 1.149 | 220 | 35 | 25 | 17 | 5.2 | 4.8 |
| 1d | GUR ® 4012 | 1.149 | 240 | 25 | 25 | 17 | 5.3 | 4.8 |

¹GUR ® 4012 is produced and sold by Ticona LLC. The specification range of the molecular weight for GUR ® 4012 is about 927,000 to about 1,616,000 g/mol. The mid-range of the specification is about 1,259,000 g/mol.

TABLE 2
PRESENT INVENTION

| | | | | | | Average | | |
|---|---|---|---|---|---|---|---|---|
| | | | | Sintering | Pressure | pore | Flexural | |
| | | Mw × 10⁶ | | time | Drop | size | strength | |
| Example | Polymer | g/mol | Temperature ° C. | (min) | (mbar) | (μm) | (mPas) | Shrinkage % |
| 2a | GUR ® 4022² | 2.62 | 220 | 25 | 20 | 14 | 3.6 | 4.5 |
| 2b | GUR ® 4022 | 2.62 | 220 | 30 | 19 | 16 | 3.2 | 4.5 |
| 2c | GUR ® 4022 | 2.62 | 220 | 35 | 21 | 14 | 3.3 | 4.4 |
| 2d | GUR ® 4022 | 2.62 | 240 | 25 | 22 | 16 | 3.2 | 4.4 |

²GUR ® 4022 is produced by Ticona LLC.

TABLE 3
COMPARATIVE DATA

| | | | | | | Average | | |
|---|---|---|---|---|---|---|---|---|
| | | | | Sintering | Pressure | pore | Flexural | |
| | | Mw × 10⁶ | | time | Drop | size | strength | |
| Example | Polymer | g/mol | Temperature ° C. | (min) | (mbar) | (μm) | (mPas) | Shrinkage % |
| 3a | GUR ® 4150³ | 5.671 | 220 | 25 | 37 | 14 | 1.6 | 4.1 |
| 3 | GUR ® 4150 | 5.671 | 220 | 30 | 36 | 12 | 1.6 | 4.4 |
| 3c | GUR ® 4150 | 5.671 | 220 | 35 | 35 | 13 | 1.5 | 4.4 |
| 3d | GUR ® 4150 | 5.671 | 240 | 25 | 40 | 13 | 1.7 | 4.6 |

³GUR ® 4150 is produced and sold by Ticona LLC. The average molecular weight is 5,671,000 g/mol.

TABLE 4
COMPARATIVE DATA

| | | | | | | Average | | |
|---|---|---|---|---|---|---|---|---|
| | | | | Sintering | Pressure | pore | Flexural | |
| | | Mw × 10⁶ | | time | Drop | size | strength | |
| Example | Polymer | g/mol | Temperature ° C. | (min) | (mbar) | (μm) | (mPas) | Shrinkage % |
| 4a | GUR ® 4120⁴ | 3.479 | 220 | 25 | 33 | 13 | 1.7 | 4.4 |
| 4b | GUR ® 4120 | 3.479 | 220 | 30 | 33 | 13 | 1.7 | 4.5 |
| 4c | GUR ® 4120 | 3.479 | 220 | 35 | 34 | 13 | 1.7 | 4.4 |
| 4d | GUR ® 4120 | 3.479 | 240 | 25 | 36 | 12 | 1.8 | 4.7 |

⁴GUR ® 4120 is produced and sold by Ticona LLC. The specification range of the molecular weight for GUR ® 4120 is about 2,816,000 to about 4,177,000 g/mol. The mid-range of the specification is about 3,479,000 g/mol.

TABLE 5
COMPARATIVE DATA

| | | | | | | Average | | |
|---|---|---|---|---|---|---|---|---|
| | | | | Sintering | Pressure | pore | Flexural | |
| | | Mw × 10⁶ | | time | Drop | size | strength | |
| Example | Polymer | g/mol | Temperature ° C. | (min) | (mbar) | (μm) | (mPas) | Shrinkage % |
| 5a | GHR ® 8110⁵ | 0.593 | 160 | 50 | 28 | 15 | 10.8 | 5.1 |
| 5b | GHR ® 8110 | 0.593 | 160 | 60 | 37 | 13 | 11.1 | 5.1 |
| 5c | GHR ® 8110 | 0.593 | 180 | 25 | 28 | 15 | 11.6 | 4.7 |
| 5d | GHR ® 8110 | 0.593 | 180 | 30 | 37 | 13 | 10.2 | 5.6 |
| 5e | GHR ® 8110 | 0.593 | 180 | 35 | 56 | 12 | 11.9 | 5.8 |

⁵GHR ® 8110 is produced and sold by Ticona LLC. The average molecular weight is 593,000 g/mol.

TABLE 6
COMPARATIVE DATA

| | | | | | | Average | | |
|---|---|---|---|---|---|---|---|---|
| | | | | Sintering | Pressure | pore | Flexural | |
| | | Mw × 10⁶ | | time | Drop | size | strength | |
| Example | Polymer | g/mol | Temperature ° C. | (min) | (mbar) | (μm) | (mPas) | Shrinkage % |
| 6a | GHR ® 8020⁶ | 0.330 | 150 | 40 | 21 | 21 | 13.3 | 4.4 |
| 6b | GHR ® 8020 | 0.330 | 150 | 60 | 58 | 17 | 12.8 | 4.4 |
| 6c | GHR ® 8020 | 0.330 | 170 | 25 | 19 | 21 | 12.3 | 4.4 |
| 6d | GHR ® 8020 | 0.330 | 170 | 30 | 156 | 14 | 15.4 | 4.4 |
| 6e | GHR ® 8020 | 0.330 | 170 | 35 | 1200 | 6 | 14.9 | 4.4 |

⁶GHR ® 8020 is produced and sold by Ticona LLC. The typical molecular weight is 330,000 g/mol (GPC measurement).

The comparative data in Tables 3-6 demonstrate that resins in the upper UHMW-PE range, e.g., with a molecular weight of 5,671,000 g/mol, offer good processing behavior. However, samples made from UHMW-PE in the upper molecular weight range are characterized by poor flexural strength. Resins with a molecular weight in the lower range, i.e., 600,000 g/mol or less, cannot be processed to porous parts at a temperature as high as 220° C. or 240° C. These samples did not have any porosity as they are totally compact. At a lower temperature, e.g., 150° C.-180° C., molding time has to be increased dramatically to process porous parts. Also, small variations in molding time and/or molding temperature can significantly affect the pressure drop and average pore size of the porous part.

Surprisingly, as shown in Tables 1 and 2, none of the negative effects reported in Tables 3-6 for the other polyethylene polymers, are observed with the invention. There is a distinct improvement in porosity, strength and flexibility when a porous article is prepared with a polyethylene powder having a molecular weight falling within the molecular weight range of the invention. Tables 1 and 2 demonstrate that even an increased temperature from 220° C. to 240° C. showed no negative impact on the porous properties or flexural strength at 25 minutes sintering time. Advantageously, the samples prepared with the prescribed polyethylene polymer are characterized by well-controlled porosity and flow resistance, good mechanical strength and excellent processing flexibility. These improvements are unexpectedly achieved with the polyethylene polymer of the invention and without blending the polyethylene powder with a polyethylene wax.

It is understood that the above described embodiments of the invention are illustrative only and that modification throughout may occur to one skilled in the art. Accordingly, this invention is not regarded as limited to the embodiments disclosed herein.

What is claimed is:

1. A process for forming a porous article comprising:
(a) providing a molding powder comprising polyethylene polymer particles, wherein the polyethylene polymer has a molecular weight within the range of about 800,000 g/mol to about 3,500,000 g/mol as determined by ASTM-D 4020, and wherein the particle size distribution of the particles of the polyethylene polymer are within the range of about 10 microns to about 1000 microns;
(b) forming the molding powder into a desired shape; and
(c ) heating the shape to a temperature within the range of about 140° C. and about 300° C. while maintaining the shape under pressure sufficient to maintain the volume of the shape and for a period of time sufficient to permit the polyethylene polymer to expand and soften; and
(d) thereafter cooling the shape.

2. The process according to claim 1, wherein the polyethylene polymer has a single modal molecular weight distribution.

3. The process according to claim 1, wherein the polyethylene polymer has a molecular weight within the range of about 1,000,000 g/mol to about 2,6000,000 g/mol as determined by ASTM-D 4020.

4. The process according to claim 1, wherein the polyethylene polymer has a molecular weight within the range of about 1,000,000 g/mol to about 1,700,000 g/mol as determined by ASTM-D 4020.

5. The process according to claim 1, wherein the temperature is within the range of about 160° C. and about 280° C.

6. The process according to claim 1, wherein the temperature is within the range of about 180° C. and about 240° C.

7. A porous article prepared in accordance with any one of claims 1-6.
